(19) United States
(12) Patent Application Publication
(10) Pub. No.: US 2015/0142931 A1
(43) Pub. Date: May 21, 2015

(54) SYSTEMS AND METHODS FOR CONTENT BROWSING, GENERATION, AND INTERACTION

(71) Applicant: Tencent Technology (Shenzhen) Company Limited, Shenzhen (CN)

(72) Inventor: Liang DONG, Shenzhen (CN)

(73) Assignee: Tencent Technology (Shenzhen) Company Limited, Shenzhen (CN)

(21) Appl. No.: 14/608,747

(22) Filed: Jan. 29, 2015

Related U.S. Application Data
(63) Continuation of application No. PCT/CN2013/085624, filed on Oct. 22, 2013.

(30) Foreign Application Priority Data
Oct. 31, 2012 (CN) 201210428221.X

(51) Int. Cl. G06F 17/30; H04L 29/08

(52) U.S. Cl. CPC G06F 17/30864; H04L 67/32
USPC 709/219

(57) ABSTRACT

Systems and methods for content browsing, generation, and interaction may comprise a content browsing terminal and a content server. In an aspect of the systems and methods, the content browsing terminal may select a plurality of subscription aggregator sources according to a user request, generate a subscription list according to the plurality of subscription aggregator sources; send the subscription list to a content server; and receive content for browsing from the content server.

### PRIORITY STATEMENT

This application is a continuation of International Application No. PCT/CN2013/085624, filed on Oct. 22, 2013, in the State Intellectual Property Office of the People's Republic of China, which claims the priority benefit of Chinese Patent Application No. 201210428221.X filed on Oct. 31, 2012, the disclosures of which are incorporated herein in their entirety by reference.

### FIELD

The present disclosure relates to Internet technologies. Specifically, the present disclosure relates to systems and methods for resource conservative content browsing, generation, and interaction.

### BACKGROUND

Along with the development of Internet technologies and browser terminals, more and more people spend their spare time browsing news and novels online. Generally, when a user wishes to browse an online subscription aggregator (SA) source (e.g., a news SA source, novel SA source or micro-blogging SA source) the user will individually send a request for browsing the respective content. For example, if a user wishes to browse three SAs sources A, B and C, the user will individually send three requests to acquire the respective contents.

Such settings require a user to send multiple requests and have multiple interactions with servers of the SA sources in order to browse contents from the multiple SAs sources at the same time. Also, the delayed return of content may affect the content browsing operation being performed by the user.

### SUMMARY

According to aspects of the present disclosure, a content browsing terminal for browsing aggregated subscribed contents from subscription aggregator source may comprise at least one module, wherein the at least one module may be configured to select a plurality of subscription aggregator (SA) sources according to a user request, wherein the user request may define contents to receive from the plurality of SA sources; generate a subscription list associated with the plurality of SA sources; send the subscription list to a content server; receive content for browsing from the content server, wherein the content for browsing may be a combination of the defined contents acquired from the plurality of SA sources; and display the content for browsing on the browsing terminal.

For a better understanding of the present disclosure, exemplary embodiments thereof are described in detail in connection with the accompanying drawings as follows:

### BRIEF DESCRIPTION OF THE DRAWINGS

FIG. 1 is a process flow diagram of a content browsing method according to example embodiments of the present disclosure;

FIG. 2 is a process flow diagram of a content generation method according to the example embodiments of the present disclosure;

FIG. 3 is a process flow diagram of a content interaction method according to the example embodiments of the present disclosure;

FIG. 4 is a schematic block diagram of a content browsing terminal, content server, and content interaction system according to the example embodiments of the present disclosure;

FIG. 5 illustrates a schematic diagram illustrating an example embodiment of a client device;

FIG. 6 illustrates a schematic diagram illustrating an example embodiment of a server; and

FIG. 7 illustrates a system that implements a content interaction method according to the example embodiments of the present disclosure.

### DETAILED DESCRIPTION

Example embodiments will now be described more fully with reference to the accompanying drawings, in which the example embodiments are shown. The example embodiments may, however, be embodied in many different forms and should not be construed as being limited to the example embodiments set forth herein; rather, the example embodiments are provided so that this Application will be thorough and complete, and will fully convey the concept of the invention to one skilled in the art. The drawings may be exaggerated for clarity and not necessarily in scale. Like reference numerals in the drawings denote like elements, and thus, their description will not be repeated. Words related to direction used in the present disclosure, e.g. “above”, “below”, “front”, “back”, “left”, “right”, “inside”, and “outside”, are with reference to the directions of the accompanying drawings. Accordingly, those words related to directions are intended for the illustration and understanding of the present disclosure, and not for limiting the scope thereof.

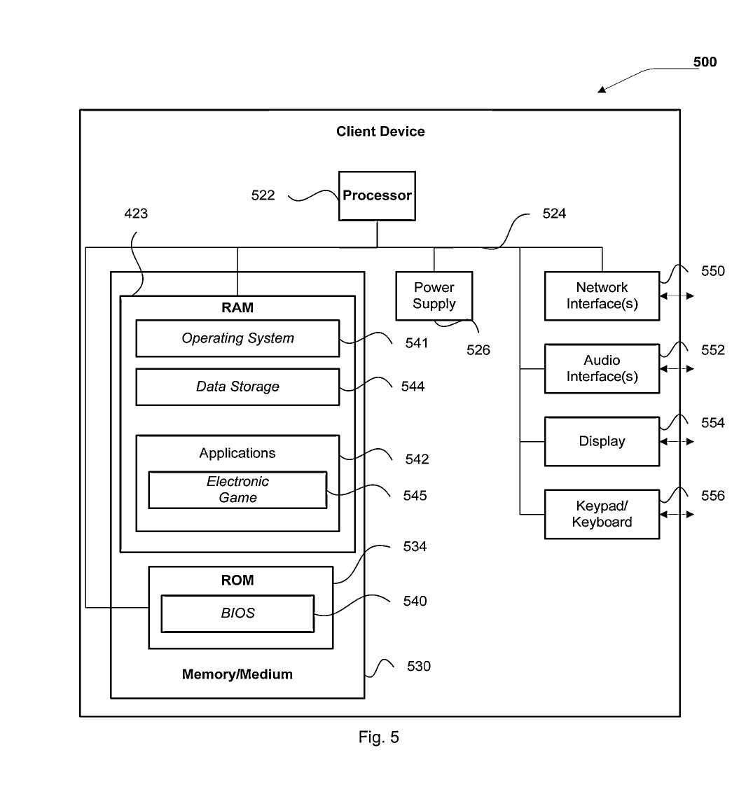

FIG. 5 illustrates a schematic diagram illustrating an example embodiment of a client device that may be a content browsing terminal as introduced in the present disclosure. The client device may comprise apparatus to execute methods and software systems introduced in the present disclosure. A client device 500 may be a computing device, which comprises a processor, capable of executing a software system. The client device 500 may, for example, be a device such as a personal desktop computer or a portable device, such as a laptop computer, a tablet computer, a cellular telephone, or a smart phone.

The client device 500 may vary in terms of capabilities or features. Claimed subject matter is intended to cover a wide range of potential variations. For example, the client device 500 may comprise a keypad/keyboard 556. It may also comprise a display 554, such as a liquid crystal display (LCD), or a display with a high degree of functionality, such as a touch-sensitive color 2D or 3D display. In contrast, however, as another example, a web-enabled client device 500 may comprise one or more physical or virtual keyboards, and mass storage medium 530.

The client device 500 may also comprise or may execute a variety of operating systems 541, comprising an operating system, such as a Windows™ or Linux™, or a mobile operating system, such as iOS™, Android™, or Windows Mobile™. The client device 500 may comprise or may execute a variety of possible applications 542, such as an electronic game 545. An application 542 may enable communication with other devices via a network, such as communicating with another computer or content server via a network for online content browsing.

Further, the client device 500 may comprise one or more non-transitory processor-readable storage media 530 and one or more processors 522 in communication with the non-transitory processor-readable storage media 530. For example, the non-transitory processor-readable storage media 530 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 530 may store sets of instructions, or units and/or modules that comprise the sets of instructions, for conducting operations and/or method steps described in the present disclosure. Alternatively, the units and/or modules may be hardware disposed in the client device 500 configured to conduct operations and/or method steps described in the present disclosure. The one or more processors may be configured to execute the sets of instructions and perform the operations in example embodiments of the present disclosure.

Merely for illustration, only one processor will be described in client devices that execute operations and/or method steps in the following example embodiments. However, it should be note that the client devices in the present disclosure may also comprise multiple processors, thus operations and/or method steps that are performed by one processor as described in the present disclosure may also be jointly or separately performed by the multiple processors. For example, if in the present disclosure a processor of a client device executes both step A and step B, it should be understood that step A and step B may also be performed by two different processors jointly or separately in the client device (e.g., the first processor executes step A and the second processor executes step B, or the first and second processors jointly execute steps A and B).

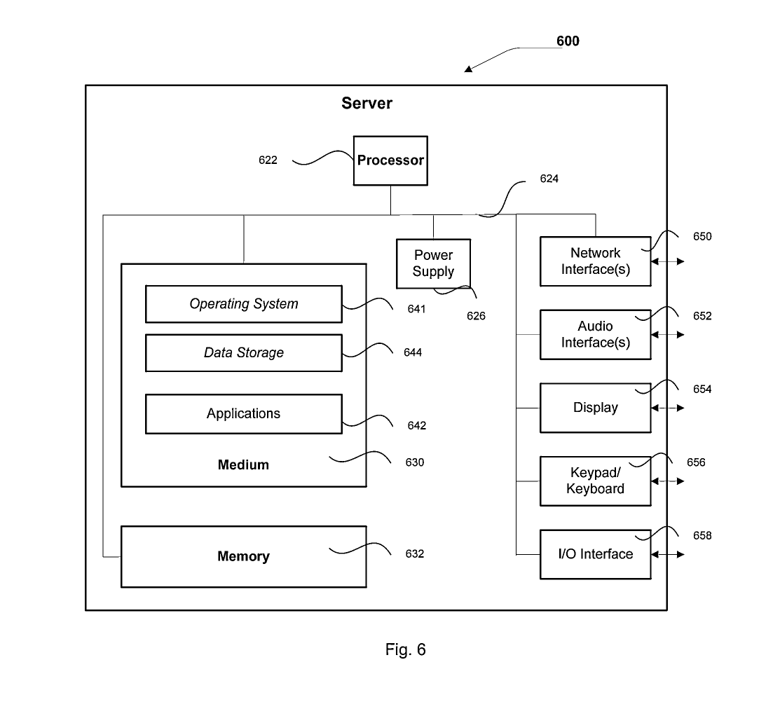

FIG. 6 illustrates a schematic diagram illustrating an example embodiment of a server device. The server device 600 may a content server as described in the present disclosure and may connect to the client device 500 locally or via a network. A Server 600 may vary widely in configuration or capabilities, but it may comprise one or more central processing units 622 and memory 632, one or more medium 630 (such as one or more mass storage devices) storing application programs 642 or data 644, one or more power supplies 626, one or more wired or wireless network interfaces 650, one or more input/output interfaces 658, and/or one or more operating systems 641, such as Windows Server™, Mac OS X™, Unix™, Linux™, FreeBSD™, or the like. Thus a server 600 may comprise, as examples, dedicated rack-mounted servers, desktop computers, laptop computers, set top boxes, mobile computational devices such as smart phones, integrated devices combining various features, such as two or more features of the foregoing devices, or the like.

The server 600 may serve as a search server or a content server. A content server 107 may comprise a device that comprises a configuration to provide content via a network to another device. A content server may, for example, host a site, such as a social networking site, examples of which may comprise, but are not limited to, Flicker™ Twitter™, Facebook™, LinkedIn™, or a personal user site (such as a blog, vlog, online dating site, etc.). A content server 107 may also host a variety of other sites, comprising, but not limited to business sites, educational sites, dictionary sites, encyclopedia sites, wikis, financial sites, government sites, etc. A content server 107 may further provide a variety of services that comprise, but are not limited to, web services, third party services, audio services, video services, email services, instant messaging (IM) services, SMS services, MMS services, FTP services, voice over IP (VOIP) services, calendaring services, photo services, or the like. Examples of content may comprise text, images, audio, video, or the like, which may be processed in the form of physical signals, such as electrical signals, for example, or may be stored in memory, as physical states, for example. Examples of devices that may operate as a content server comprise desktop computers, multiprocessor systems, microprocessor type or programmable consumer electronics, etc.

FIG. 1 is a process flow diagram a content browsing method according to example embodiments of the present disclosure.

In Step 101, a content browsing terminal may select one or more subscription aggregator (SA) sources (hereinafter “SA sources”) according to a request from a user of the content browsing terminal, and generate a subscription list according to the selected SA sources. The subscription list may comprise a SA source number of the SA source. In Step 102, the content browsing terminal may send the subscription list to a content server and receive content that the subscription list requests for a user to browse (hereinafter “content for browsing”) from the content server. Finally, the content for browsing may be displayed on the content browsing terminal for the user to browse. Details of the above steps are described below.

In Step 101, the content browsing terminal (i.e., a processor of the content browsing terminal) may receive a subscription content browsing request (user request) from a user. The user request may comprise the SA sources the user wishes to browse and may define contents to receive from the SA sources. A subscription aggregator may be a software application or a web application which aggregates syndicated web content, such as from a technology website, a news website, a shopping website, a social network website, and a music website, in one location for easy viewing. Further, the content browsing terminal may be the client device 500 and may be associated with the SA sources.

The content browsing terminal may also receive multiple user requests to select multiple SA sources the user wishes to browse. When the foregoing SA sources have been selected, the content browsing terminal may convert the selected SA sources to a subscription list (i.e., when the user have completed selecting the SA sources, the content browsing terminal may put all the selected SA sources together and generate one subscription list for all the selected SA sources). The subscription list may comprise a SA source number for each SA source to differentiate the selected SA sources. The subscription list may also comprise a local content number for each SA source, so that it is easier for the content browsing terminal and/or the user to keep track on contents for browsing that are already available on a content browsing terminal.

In Step 102, the content browsing terminal may send the subscription list generated in Step 101 to a content server. The content browsing terminal may also receive the content for browsing from the content server. The content for browsing for a SA source may be determined according to the SA source number of the SA source, the local content number of the SA source, and a server content number of the SA source.

The SA source number of a SA source may be used for differentiating other selected SA sources, the local content number of a SA source may be used for identifying contents from the SA source that are already available on the content browsing terminal, and the server content number of a SA source may be used for identifying newly updated contents for browsing from the SA source. Accordingly, the content browsing terminal may download the newly updated contents for browsing from the SA source onto the content browsing terminal according to the local content number of the SA source and the server content number of the SA source.

In order for the user to rapidly acquire latest information from the SA sources, the content browsing terminal may display the contents for browsing received from the content server sequentially according to the time that the contents for browsing are released and/or updated from the corresponding SA source.

The content for browsing received from the content server may comprise, but is not limited to, a subscription summary and full subscription content from each SA source listed in the subscription list. For example, the content for browsing received from the content server may comprise the full subscription content. Alternatively, the content for browsing received from the content server may comprise only the subscription summary. Because the subscription summary is shorter (thereby are smaller in size) and comprises greater density of information, a user may feel more convenient for quick browsing. If the user shows interested in knowing more about the information introduced in a subscription summary, he/she may send a command to the content browsing terminal to download the respective full subscription content for further browsing.

According to the example embodiments of the present disclosure, when the content browsing terminal receives a user subscription request of a SA source, the content browsing terminal may not send the request immediately to the content server; instead, the content browsing terminal may wait until all SA sources that the user wishes to browse have been selected and a “selection completed” command has been received from the user (the client device may comprise a “Confirm” push-button configured to send the “selection completed” command), and then convert the selected SA sources into a subscription list. The content browsing terminal them may send the subscription list the content server in a single time (e.g., all the selected subscription requests are sent together as a whole package) to acquire the corresponding subscription summaries and/or full subscription contents of all the selected SA sources. In response, the content server may identify the content for browsing from each SA source according to the SA source number of the SA source. Because the SA source number may be used for differentiating various SA sources, the content browsing method of the present disclosure may be capable of reducing the number of interactions between the content browsing terminal and the content server, thereby greatly conserving system resources.

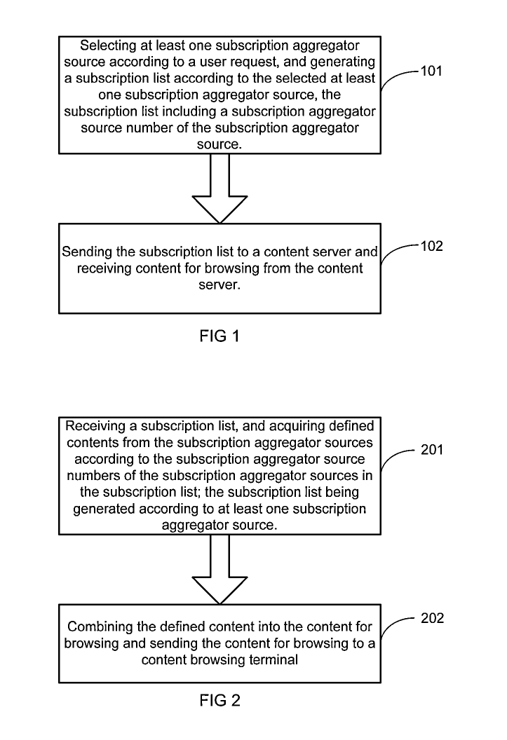

FIG. 2 is a process flow diagram of a content generation method according to the example embodiments of the present disclosure.

In Step 201, a content server (i.e., a processor of the content server) may first receive a subscription list from a content browsing terminal in communication with the content server. The content server may be the server 600. The subscription list may be generated by the content browsing terminal in communication with the content server and may comprise a SA source number for each SA source in the subscription list. The content server then may acquire contents defined from the subscription list (hereinafter “defined contents”) from the at least one SA sources according to the at least one SA source number. In Step 202, the content server may generate content for browsing by combining the defined contents acquired from the SA sources together and send the content for browsing to the content browsing terminal.

The detailed steps of the content generating method according to the example embodiments of the present disclosure are further described below.

In Step 201, the content server may receive the subscription list sent from the content browsing terminal and acquire all SA sources cited in the subscription list. The content server then may acquire the defined contents of the SA source according to the SA source number of the SA source. The subscription list may further comprise local content numbers of the SA sources. Accordingly, the content server may download contents of a SA source (consisting of the acquired contents of the SA source) that have not yet been downloaded onto the content browsing terminal of a user as the defined contents, according to the local content number of the SA source and the server content number of the SA source in the content server.

In Step 202, processor of the content server may generate the content for browsing by combining the defined contents together, and then send the content for browsing to the content browsing terminal. The content for browsing may be displayed according to the time sequence that the defined contents were released to facilitate rapid acquisition of latest information by the user. At the same time, the content for browsing may comprise, but is not limited to, a subscription summary and/or full subscription content for each SA sources in the subscription list. For example, the content for browsing may comprise only the full subscription content. Alternatively, the content for browsing may comprise the subscription summary because it is shorter and has larger density of information, and thereby may be convenient for quick browsing. When a user is more interested in the information in the subscription summary, the user may send a command to the content browsing terminal to download the respective full subscription content for detailed browsing.

According to the example embodiments of the present disclosure, when employing the content generation method of the example embodiment, to coordinate with the corresponding content browsing terminal, the content server may acquire and/or receive all the SA sources in the subscription list and acquire the respective defined contents from the SA sources according to the corresponding SA source numbers of the listed SA sources. The content server may then combine the acquired contents into the content for browsing, and send the content for browsing to the content browsing terminal lump sum (e.g., all the acquired contents are sent together as a whole package). Hence the content generation method of the present disclosure may be able to reduce the number of interactions between the content browsing terminal and the content server, thereby greatly conserve system resources.

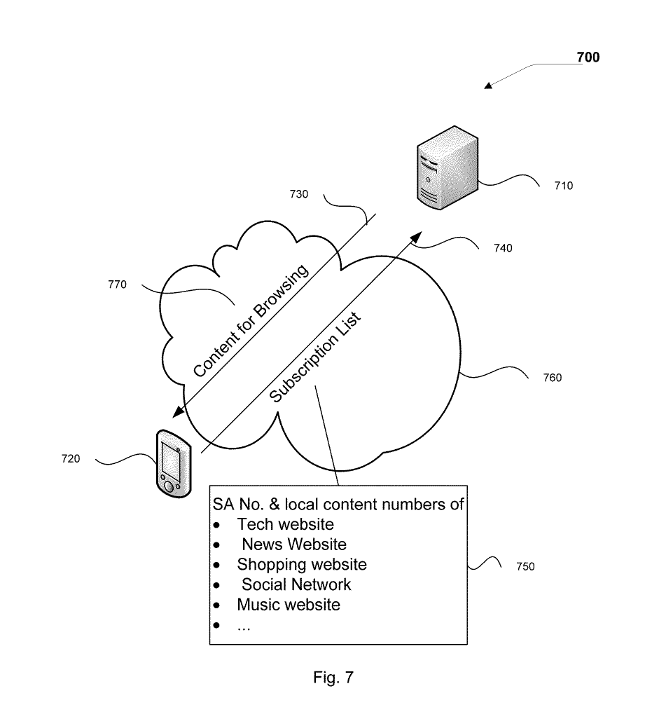

FIG. 7 illustrates a system that implements a content interaction method according to the example embodiments of the present disclosure. A system 700 may comprise a browsing terminal 720 and a content server 710 that is in communication with the content browsing terminal 720 via a network 760. The browsing terminal 720 may be a client device 500 in FIG. 5. The content server 710 may be the server 600 in FIG. 6. The network 760 may be Internet, one or more local area networks (LANs) and/or wide area networks (WANs), wire-line type connections, wireless type connections, or any combination thereof. The network 760 may couple devices so that communications may be exchanged, such as between the content servers (e.g., the content server 710) and client devices (e.g., the content browsing terminal 720) or other types of devices, including between wireless devices coupled via a wireless network.

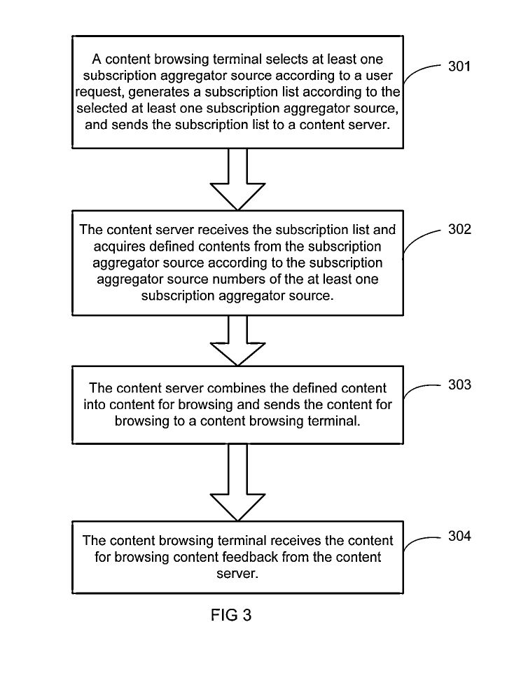

FIG. 3 is a process flow diagram of the content interaction method implemented by the system 700 in FIG. 7, according to the example embodiments of the present disclosure.

In Step 301, the content browsing terminal 720 may select a number of SA sources according to a request from a user. For example, the SA sources may be one or more of a technology website, a news website, a shopping website, a social network website, and a music website. The content browsing terminal 720 then may generate a subscription list 750 according to the selected SA sources, and send the subscription list to the content server 710. In Step 302, the content server 710 may receive the subscription list 750 and acquire the defined contents from the SA sources according to their corresponding SA source numbers. In Step 303, the content server 710 may combine the defined contents from the SA sources into the content for browsing 770 and send the content for browsing 770 to the content browsing terminal 720. In Step 304, the content browsing terminal 720 may receive the content for browsing 770 from the content server 710.

The detailed steps of the content interaction method are introduced below.

In Step 301, the content browsing terminal 720 may receive a user request of browsing subscription content. Once the user has completed SA sources selection, the content browsing terminal may convert the selected SA sources to a subscription list. The subscription list may comprise the SA source numbers of the SA sources to differentiate the selected SA sources. The subscription list may also comprise the local content numbers of the SA sources to facilitate awareness of contents of SA sources already available on the content browsing terminal. Thereafter, the content browsing terminal 720 may send the subscription list to the content server 710.

In Step 302, the content server 710 may receive the subscription list sent from the content browsing terminal 720, acquire all SA sources in the subscription list, and acquire the defined contents of the user request from the SA sources according to their corresponding SA source numbers. The subscription list may further comprise the local content numbers of the SA sources. The content server 710 may then download the defined content of a SA source that has not yet been downloaded onto the content browsing terminal 720 of a user according to the local content number of the SA source and the server content number of the SA source in the content server.

In Step 303, the content server 710 may combine the defined contents acquired from the listed SA sources into content for browsing 770 and send the content for browsing 770 to the content browsing terminal 720. The content for browsing 770 may be displayed on the content browsing terminal 720 according to the time sequence that the defined contents are released and/or updated to facilitate rapid acquisition of latest information by the user. The content for browsing 770 may comprise, is but is not limited to, a subscription summary and/or full subscription content.

In Step 304, the content browsing terminal 720 may receive the content for browsing from the content server 710.

Finally, the content browsing terminal may send and/or display the content for browsing to the user.

The operational principles of the example embodiments of the content interaction method may be identical or similar to those of the example embodiments of the content browsing method and/or the example embodiments of the content generation method set forth above.

In the content interaction method, the content browsing terminal 720 may send the subscription list 750 lump sum to the content server 710 to acquire the subscription summaries and/or full subscription contents of all the selected SA sources. The content server 710 may combine the defined content of each SA source to form the content for browsing 770, and send the content for browsing 770 lump sum to the content browsing terminal 720 for browsing by the user. The content interaction method of the present disclosure thereby may reduce the number of interactions between the content browsing terminal 720 and the content server 710, and conserve system resources.

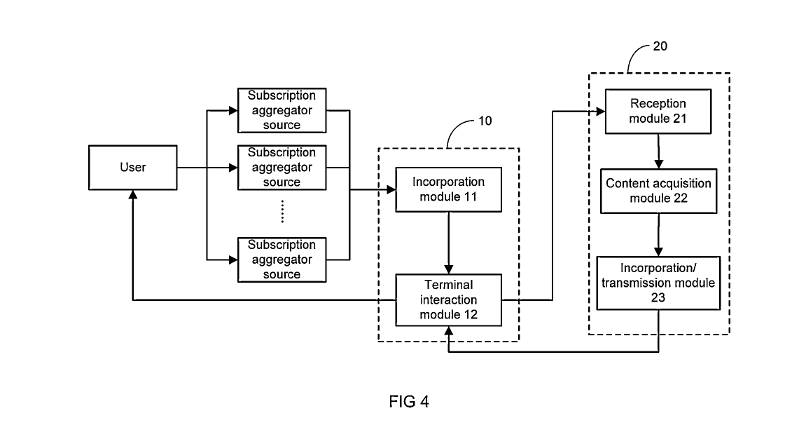

FIG. 4 is a schematic block diagram of a content browsing terminal, content server and content interaction system according to example embodiments of the present disclosure.

The content interaction system may comprise a plurality of content browsing terminals 10 and at least one content server 20. Merely for illustration, FIG. 4 only show one content browsing terminal 10 and one content server 20. The content browsing terminal 10 may be the client device 500 in FIG. 5; and the content server 20 may be the server 600 in FIG. 6.

The content browsing terminal 10 may comprise an incorporation module 11 and a terminal interaction module 12. The incorporation module 11 may be configured to select the SA sources according to a user request, and generate a subscription list according to the selected SA sources. The subscription list may comprise a SA source number for each SA source; and the terminal interaction module 12 may be configured to send the subscription list to the content server 20 and receive content for browsing from the content server 20.

The content server 20 may comprise plurality of modules as describe below implemented on one or more processors. For example, the content server 20 may comprise a reception module 21, a content acquisition module 22, and an incorporation/transmission module 23. The reception module 21 may be configured to receive the subscription list. The content acquisition module 22 may be configured to acquire contents of the SA sources in the subscription list according to the respective SA source numbers of the SA sources in the subscription list. The subscription list may be generated by the content browsing terminal 10 according to the SA sources; and the incorporation/transmission module 23 may be configured to combine the defined contents into the content for browsing and send the content for browsing to content browsing terminal 10.

When the content interaction system is in use, the incorporation module 11 of the content browsing terminal 10 may receive a user request, select the SA sources the user wishes to browse according to the user request, and convert the selected SA sources into a subscription list. The subscription list may comprise the SA source numbers of the selected SA sources and the local content numbers of the SA sources.

The terminal interaction module 12 of the content browsing terminal 10 may send the subscription list generated by the incorporation module 11 to the reception module 21 of the content server 20. The content acquisition module 22 of the content server 20 may acquire all the SA sources in the subscription list and then acquire the respective defined contents from the selected SA sources according to their SA source numbers. Further, the content acquisition module 22 may select those contents of the SA sources (e.g., the contents may comprise the defined contents of the SA sources) that have not yet been downloaded onto the content browsing terminal 10 according to the local content numbers of the SA sources and the server content numbers of the SA sources in the content server 20.

Next, the incorporation/transmission module 23 of the content server 20 may combine the defined contents into the content for browsing and send the content for browsing to the terminal interaction module 12 of the content browsing terminal 10 for browsing by the user. The content for browsing may be displayed according to the time sequence of content release. At the same time, the content for browsing may comprise, but is not limited to, a subscription summary and/or full subscription content.

The operational principles of the example embodiments of the content browsing terminal 10 may be identical or similar to that of the example embodiments of the content browsing method. The operational principles of the example embodiments of the content server 20 may be identical or similar to that of the example embodiment of the embodiment of the content generation method.

Processes of example embodiments of the content browsing terminal, content server and content interaction system of the present disclosure are described below in connection with FIG. 4.

First, the content browsing terminal 10 (such as a mobile phone terminal and/or a client device 500) may receive a user request and select SA sources (e.g., www.cnBeta.com, www.TechWeb.com and www.36kr.com) according to the user request; once the user completes the selection, the selected SA sources may be converted into a subscription list and the subscription list may be sent to the content server 20.

The content server 20 may acquire all SA sources in the subscription list, acquire corresponding contents of the SA sources from the respective content server(s) according to the local content numbers of the SA sources and the server content numbers of the SA sources. The content server 20 may then combine the acquired contents of the listed SA sources into the content for browsing, and may send the content for browsing to the content browsing terminal 10.

The content browsing terminal 10 may receive the content for browsing and provides to the user for browsing.

The content browsing method, generation method and interaction method, and the content browsing terminal, server and interaction system of the present disclosure may reduce the number of interactions between the content browsing terminal and the content server by incorporating browsing requests of multiple SA sources into a subscription list of browsing requests, thereby may conserve system resources. At the same time, the reduction of the number of interactions may reduce network error probability and provide greater stability to the operations of the content browsing terminal and the content server. In addition, analyses of the subscription list may enable better understanding of users' browsing behaviors and thereby provide better data support for future content production.

While example embodiments of the present disclosure relate to systems and methods for content browsing, generation, and interaction, the systems and methods may also be applied to other Applications. For example, in addition to mobile terminals, the methods and apparatus may also be applied to non-mobile devices such as a desk top computer, a server of a network, or any devices that may be operated by a user to browse internet contents, etc. The present disclosure intends to cover the broadest scope of systems and methods for content browsing, generation, and interaction.

Thus, example embodiments illustrated in FIGS. 1-7 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

1. A content browsing terminal device for browsing aggregated subscribed contents from subscription aggregator source, comprising:
at least one module, wherein the at least one module is implemented on a processor configured to:
select a plurality of subscription aggregator (SA) sources according to a user request, wherein the user request defines contents to receive from the plurality of SA sources;
generate a subscription list associated with the plurality of SA sources;
send the subscription list to a content server;
receive content for browsing from the content server, wherein the content for browsing is a combination of the defined contents acquired from the plurality of SA sources; and
display the content for browsing on the browsing terminal.

2. The content browsing terminal device according to claim 1, wherein the subscription list comprises a SA source number for each of the plurality of SA sources, a local content number for each of the plurality of SA sources; and
the content for browsing is associated with the SA source numbers of the plurality of SA sources, the local content numbers of the plurality of SA sources, and a server content number of each of the plurality of SA sources.

3. The content browsing terminal device according to claim 2, wherein the SA source number of a SA source is configured to differentiate other selected SA sources;
the local content number of a SA source is configured to identify contents from the SA source that are already available on the content browsing terminal; and
the server content number of a SA source is configured to identify newly updated contents for browsing from the SA source.

4. The content browsing terminal device according to claim 2, wherein the defined contents acquired from the plurality of SA source are acquired based on the local content numbers of the plurality of SA sources in the subscription list and the server content numbers of the plurality of SA sources in the content server.

5. The content browsing terminal device according to claim 1, wherein the at least one module is further configured to:
display the content for browsing according to a time sequence that the defined contents acquired from the plurality of SA sources are released.

6. The content browsing terminal device according to claim 1, wherein the content for browsing comprises at least one of a subscription summary and full subscription content for each of the plurality of SA sources.

7. The content browsing terminal device according to claim 1, wherein the content for browsing comprises a subscription summary for each of the plurality of SA sources, and
the at least one module is further configured to:
download full subscription content from a SA source of the plurality of SA sources that corresponds to the subscription summary when the content browsing terminal receives an command from a user to further read the full subscription content.

8. The content browsing terminal device according to claim 1, wherein the defined contents acquired from the plurality of SA sources are contents that have not yet been downloaded onto the content browsing terminal.

9. The content browsing terminal device according to claim 1, wherein the at least one module is in communication with the content server via a network.

10. The content browsing terminal device according to claim 1, wherein the subscription list is sent to the content server lump sum; and
the content for browsing is received from the content server lump sum.

11. A method, comprising:
selecting, by a content browsing terminal device, a plurality of subscription aggregator (SA) sources according to a user request, wherein the user request defines contents to receive from the plurality of SA sources;
generating, by the content browsing terminal device, a subscription list associated with the plurality of SA sources;
sending, by the content browsing terminal device, the subscription list to a content server;
receiving, by the content browsing terminal device, content for browsing from the content server, wherein the content for browsing is a combination of the defined contents acquired from the plurality of SA sources; and
displaying, on the content browsing terminal device, the content for browsing.

12. The method according to claim 11, wherein the subscription list comprises a SA source number for each of the plurality of SA sources, a local content number for each of the plurality of SA sources; and
the content for browsing is associated with the SA source numbers of the plurality of SA sources, the local content numbers of the plurality of SA sources, and a server content number of each of the plurality of SA sources.

13. The method according to claim 12, wherein the SA source number of a SA source is configured to differentiate other selected SA sources;
the local content number of a SA source is configured to identify contents from the SA source that are already available on the content browsing terminal device; and
the server content number of a SA source is configured to identify newly updated contents for browsing from the SA source.

14. The method according to claim 12, wherein the defined contents acquired from the plurality of SA source are acquired based on the local content numbers of the plurality of SA sources in the subscription list and the server content numbers of the plurality of SA sources in the content server.

15. The method according to claim 11, further comprising:
displaying, on the content browsing terminal device, the content for browsing according to a time sequence that the defined contents acquired from the plurality of SA sources are released.

16. The method according to claim 11, wherein the content for browsing comprises at least one of a subscription summary and full subscription content for each of the plurality of SA sources.

17. The method according to claim 11, wherein the content for browsing comprises a subscription summary for each of the plurality of SA sources, and
the method further comprising:
downloading, by the content browsing terminal device, full subscription content from a SA source of the plurality of SA sources that corresponds to the subscription summary when the content browsing terminal device receives an command from a user to further read the full subscription content.

18. The method according to claim 11, wherein the defined contents acquired from the plurality of SA sources are contents that have not yet been downloaded onto the content browsing terminal device.

19. The method according to claim 11, wherein the at least one module is in communication with the content server via a network.

20. The method according to claim 11, wherein the subscription list is sent to the content server lump sum; and
the content for browsing is received from the content server lump sum.
